(19) United States
(12) Patent Application Publication
(10) Pub. No.: US 2025/0128193 A1
(43) Pub. Date: Apr. 24, 2025

(54) Filter module and methods

(71) Applicant: Jürgen Kara, Neustadt/Coburg (DE)

(72) Inventor: Jürgen Kara, Neustadt/Coburg (DE)

(21) Appl. No.: 18/700,839

(22) PCT Filed: Oct. 14, 2022
(86) PCT No.: PCT/EP2022/078677

§ 371 Date: Apr. 12, 2024

(30) Foreign Application Priority Data
Oct. 14, 2021 (DE) 10 2021 211 593.4

(51) Int. Cl. B01D 45/16; B01D 45/02

(52) U.S. Cl. CPC B01D 45/16; B01D 45/02

(57) ABSTRACT

A filter module for separating particles from contaminated air, includes a receiving element which has an inlet side for admitting an airflow to be cleaned and an outlet side for discharging the cleaned airflow, said inlet and outlet sides being opposite each other on the receiving element, and comprising a three-dimensional filter insert received in the receiving element. The filter insert has at least two transverse walls arranged approximately parallel to each other. Each transverse wall has at least one opening which are vertically offset and/or overlap vertically such that the air flow can be deflected onto different vertical levels through the openings. A wave-shaped airflow can be formed such that particles from the airflow to be cleaned are adhered in the filter insert in a uniformly distributed manner. A method for operating such a filter module and a method for assembling same are also provided.

### CROSS REFERENCE TO RELATED APPLICATION(S)

This application is a Section 371 National Stage Application of International Application No. PCT/EP2022/078677, filed on Oct. 14, 2022, entitled “Filter module and methods”, which published as WIPO Publication No. 2023/062200 A1, on Apr. 20, 2023, not in English, which claims priority to German Patent Application No. 10 2021 211 593.4, filed on Oct. 14, 2021, the contents of which are incorporated herein by reference in their entireties.

### BACKGROUND OF INVENTION

The present invention relates to a filter module for separating particles from contaminated air. The invention additionally relates to a method for operating such a filter module and to a method for assembling same.

### TECHNICAL BACKGROUND

Filter modules are used for different applications. These can be, for example, used in spray booths to absorb paint mist. In this respect, the filter modules are used to clean the air discharged from the spray cabins. The paint particles that do not adhere to the object to be sprayed can be separated through the filter modules. Filter modules of this type can therefore also be referred to as separators or separator modules.

Typically, filter modules have an inlet side that is formed for admitting an airflow to be cleaned. Preferably, on an opposite side, there is arranged an outlet side which is used for discharging the cleaned airflow.

For example, several filter modules of the same type can be arranged next to each other or on top of each other to create a continuous surface that can be arranged below the object or at the side of the object to be sprayed. In this respect, all inlet sides are arranged on one side of the continuous surface. Preferably, as it were, behind the filter modules there is generated a negative pressure so that an air flowing from the inlet side in the direction of the outlet side is created through the filter modules. The airflow to be cleaned is guided through the filter modules and cleaned by the particles adhering inside the filter modules or being separated at the filter modules.

The prior art document EP 1 492 609 B1 showsa filter module in the form of a hollow body made of a paper material. Inside the filter module there are at least two walls arranged transversely to the direction of the entering airflow. Each of the walls has openings, wherein the openings of the walls are smaller from the inlet side in the direction of the outlet side and/or are arranged offset to one another. Through the walls, chambers are created within the basic body. The airflow to be cleaned is guided in a meandering pattern through the differently arranged openings in the walls, which are arranged one behind the other. Using a handle, there can be opened at least one chamber so that, for example, into the chamber there can be inserted a filling material.

Furthermore, a filter module is known from the EP 3 167 948 A1, which also consists of a hollow body in which different cleaning structures can be inserted. As in the EP 1 492 609 B1, the cleaning structure consists of walls with openings, wherein the walls are connected to each other via a stabilizing wall aligned transversely thereto. Within the hollow body there can be several such cleaning structures arranged one behind the other to form the filter module. Through the openings in the walls and in the stabilizing wall, the air to be cleaned is passed alternately through the walls and through the stabilizing walls through the filter module in a meandering pattern. The cleaning structures arranged one behind the other can be removed individually so that differently contaminated cleaning structures can be replaced at different times. The cleaning structures can be folded together before assembly to form the filter module and must be unfolded for installation.

A disadvantage of this type of filter module is that, due to the redirection of the airflow in different spatial directions, the adherence of the particles within the filter module varies greatly, i.e. is distributed in a very uneven manner. This is due to the meandering guidance of the airflow, whereby the airflow is diverted by approximately 90° in every possible spatial direction after entering on the inlet side. This sudden rerouting of the airflow, for example to the left, right, top or bottom within the filter module, brings about an abrupt and very strong deceleration. Consequently, most of the particles are separated in a first chamber between a first and a second wall, which is the first to be reached by the airflow to be cleaned. These chambers, which are located further back, are reached by only a small number of particles. This reduces the efficiency and service life of each filter module, as they have to be replaced already when areas further back within the filter module show only very small particle accumulations.

In the EP 3 167 948 A1, this problem is solved by a solution in which the individual cleaning structures, which are arranged one behind the other within the base body, can be removed individually. As a result, the cleaning structure arranged closest to the inlet side can be replaced.

However, during operation in a spray cabin, where several identical filter modules are usually arranged next to each other or on top of each other to form a continuous surface, the replacement of individual cleaning structures from each individual filter module is only possible at great expense of time. In particular, to replace a cleaning structure from each individual filter module, each individual hollow body must be opened. This is not possible with filter modules arranged next to or on top of each other. Accordingly, the continuous area of filter modules would first have to be dismantled so that each individual filter module is accessible. This results in an enormous amount of time. In practice, it is therefore virtually impossible to replace individual cleaning elements. As a result, experience has shown that the filter modules are already completely replaced when only the first cleaning element is so dirty that the airflow can no longer pass through this one cleaning element.

Another disadvantage is that time is lost when assembling the filter modules, as the walls or the individual cleaning elements have to be inserted into the hollow body individually. Furthermore, folding the cleaning elements into a three-dimensional element is also time-consuming and requires specialist knowledge, whereby the three-dimensional element is unstable due to the previously folded walls. Disadvantageously, the cleaning element must therefore be stiffened or fixed inside the hollow body.

### SUMMARY OF THE INVENTION

Against this background, there is a need to provide an improved filter module.

According to the invention, a filter module having the features of claim 1, a method of operating a filter module having the features of claim 19 and/or a method of assembling a filter module having the features of claim 20 are provided.

Accordingly, the present invention provides:
a. A filter module for separating particles from contaminated air, comprising a receiving element which has an inlet side for admitting an airflow to be cleaned and an outlet side for discharging the cleaned airflow, said inlet side and outlet side being arranged opposite each other on the receiving element, and comprising a three-dimensional filter insert which is received in the receiving element, wherein the filter insert has at least two transverse walls which are arranged approximately parallel to each other, and each transverse wall has at least one opening. The openings of the transverse walls are vertically offset and/or overlap vertically such that the air flowing from the inlet side in the direction of the outlet side can be deflected onto different vertical levels through the openings. A wave-shaped airflow can be formed from the inlet side to the outlet side such that particles from the airflow to be cleaned are adhered in the filter insert in a uniformly distributed manner.
b. A method for operating a filter module, in particular in a paint mist extraction system, wherein the air flowing from the inlet side in the direction of the outlet side is only deflected through the openings of the transverse walls onto within different vertical positions the filter insert, so that a wave-shaped airflow results and a deflection of the flow transverse to the different vertical positions is prevented.
c. A method of assembling a filter module, comprising the steps of: erecting the transverse walls, which are fitted into the at least one longitudinal wall one inside the other and form the filter insert, so that an approximately two-dimensional structure is turned into a three-dimensional structure comprising cavities, said structure being stable in itself; sliding the filter insert into the receiving element, in particular into an open top side of the receiving element; closing the receiving element by means of a cover, so that the filter insert can be fixed nondisplaceably in the receiving element.

The present invention is based on the underlying concept that a long-lasting and effective filter module can be configured by evenly distributing the particles between the inlet side and the outlet side.

The underlying idea of the present invention is not to abruptly decelerate or deflect the airflow, but instead to form a wave-shaped, in particular laminar, flow between the inlet side and the outlet side in order to enable balanced adherence of the particles to all transverse walls in the receiving element.

The undulating flow is preferably configured as a laminar flow between the inlet side and the outlet side. Through this turbulence can be avoided.

Advantageously, particles from the airflow to be cleaned are separated on and/or between the transverse walls. This is achieved in particular by a centrifugal force resulting from the airflow, whereby the particles are heavier than the elements of the air and sink due to inertial forces caused by gravity, i.e. downwards in particular. This can preferably achieve an even distribution of the particles in the filter insert.

In addition, such a filter module has a single filter insert that does not need to be replaced over the entire service life of the filter module, wherein all elements of the filter insert can be used until they become unusable, i.e. until they become clogged with separated particles.

Furthermore, it is advantageously possible in this way to easily and quickly set up a three-dimensional filter insert that is stable in itself. This means that the filter insert does not have to be fixed or braced in the receiving element, which also saves time. The filter insert is inherently stable thanks to the rigid transverse walls and the rigid longitudinal walls, which are never clicked, in particular during assembly.

Overall, a forced air flow can therefore be achieved that has a low initial pressure difference of <20 Pa. The time required to set up the filter module is preferably less than 30 seconds and is therefore very short compared to known filter modules. Due to the wave-shaped, in particular laminar, airflow, cake formation on the inlet side can be almost completely avoided. Overall, the separation behavior is therefore designed to be more efficient.

A transverse wall is an element that is arranged transversely to the airflow within the receiving element.

Due to the vertically offset openings and/or vertically overlapping openings, an airflow can be formed which is only slightly deflected in different vertical positions within the filter insert by the openings of adjacent transverse walls from the inlet opening in the direction of the outlet opening. Preferably, the adjacent openings are therefore oriented towards each other in such a way that a continuous deflection of the airflow can take place. Sudden deflections, in particular meandering, i.e. at an angle of approximately 90° to the direction of flow, can thus be avoided. An optimal position and/or size of the openings can be determined by artificial intelligence, for example.

An opening is a cutout within the transverse wall, in particular also within the longitudinal wall. The opening can have any shape. In particular, the opening is rectangular or square in shape. Preferably, the opening has rounded corners rather than pointed corners. This optimizes the separation of particles from the airflow to be cleaned. The remaining wall between the openings is used for receiving means of the particles. Sufficient wall should remain between the openings to form a surface for the particles. In this way, transverse walls can be formed with different sized remaining wall sections two between, for example, openings, each configured in a transverse wall. If these differently configured transverse walls are arranged one behind the other, an airflow can be generated that is deflected to different vertical positions by the differently sized remaining wall sections.

Advantageous embodiments and modifications are apparent from the dependent claims as well as from the description with reference to the drawings.

According to an advantageous embodiment, the filter insert can have at least three, in particular three to ten, transverse walls, with the openings of adjacent transverse walls being arranged vertically offset and/or vertically overlapping. Advantageously, the flow can be diverted in a targeted and, in particular, continuous manner through the offset position of the openings. This can prevent an abrupt deceleration of the flow velocity.

Preferably, at least some of the transverse walls are arranged at different distances from each other. The transverse walls that are closer to the inlet side are preferably arranged at a greater distance from each other than the transverse walls that are closer to the outlet side. This ensures that blockages caused by adhering particles are also avoided in the region of the inlet side if a large number of particles are already adhering to the transverse walls there.

According to a further development, each transverse wall can have at least two openings and a longitudinal wall can be arranged between two openings of a transverse wall, which fixes the transverse walls at a distance and prevents an airflow parallel to the transverse walls. In this way, two similar and separate flows can be configured within the filter module. The surface of the longitudinal wall can also be used to separate particles. The longitudinal wall can be connected to the transverse walls by a plug-in connection. In particular, the longitudinal wall and/or the transverse walls have slots so that the longitudinal wall can be inserted into the transverse walls.

According to one embodiment, the longitudinal wall may have at least one opening which is smaller than the smallest opening of the transverse walls, wherein the ratio of an opening of the transverse walls to the opening of the longitudinal wall is in particular 2:1.5 or greater. The ratio refers in particular e to the cross-sectional size of the opening. In this way, the flow is not diverted through the openings of the at least one longitudinal wall. Rather, the opening in the longitudinal wall serves to equalize the pressure within the cavities configured between the transverse walls and longitudinal walls within the filter insert.

According to an advantageous embodiment, at least two, in particular three to five, longitudinal walls may be included, which are arranged approximately parallel to each other, each transverse wall having at least one opening in a region between the longitudinal walls. Advantageously, a filter insert with a stable three-dimensional structure can be formed in this way.

According to a preferred embodiment, adjacent longitudinal walls can each have at least one opening which is smaller than the smallest opening of the transverse walls, wherein the ratio of an opening of the transverse walls to the opening of the longitudinal walls is in particular 2:1.5 or greater, and the openings of the longitudinal walls have identical cross-sections and/or are each arranged at the same position with respect to adjacent longitudinal walls. In particular, all openings of the longitudinal walls are configured to be smaller than each opening of the transverse walls. This also effectively prevents cross-flow, as the openings of the longitudinal walls, which are arranged at the same height, only equalize the pressure but do not deflect the airflow.

According to a particularly preferred embodiment, the transverse walls may not be arranged in the region of at least one opening of the longitudinal walls, in particular not in the region of all openings of the longitudinal walls. This ensures that the airflow is directed through the openings in the transverse walls.

According to an advantageous embodiment, the transverse walls and the at least one longitudinal wall can each have at least one slot, so that the transverse walls can be detachably inserted into one another with the at least one longitudinal wall. This allows a three-dimensional structure to be configured that can be folded or unfolded quickly and easily. Gluing, block gluing or folding of the individual components is not necessary, which greatly simplifies the manufacturing process.

According to a further development, the transverse walls can extend over an entire length between the inlet side and the outlet side and/or the at least one longitudinal wall can extend over an entire width of the receiving element, so that only one filter insert spans an interior of the receiving element. Due to the even distribution of the particles on all transverse walls or all longitudinal walls, it is therefore not necessary to replace individual elements of the filter insert in order to ensure continuous operation.

According to one embodiment, the inlet side of the receiving element can have at least one opening that corresponds to the at least one opening of the transverse wall closest to the inlet side. This allows the entry of the airflow to be cleaned into the receiving element to be optimized.

In an advantageous embodiment, the at least one longitudinal wall cannot intersect the at least one opening of the inlet side. Advantageously, this prevents the airflow from being deflected or slowed down by the longitudinal wall.

In an advantageous embodiment, the receiving element and/or the filter insert can contain a recyclable material and/or the filter module can be configured as a paper filter module. The complete filter insert is preferably made of cardboard. Advantageously, the receiving element is also configured entirely from cardboard. Such a filter module can also be easily disposed of, in particular incinerated, with particles adhering to it. The manufacturing costs are also minimal.

According to an advantageous embodiment, at least one sensor for measuring the speed of the cleaned airflow and/or for measuring a resistance value can be arranged at the outlet opening. Advantageously, this makes it possible to determine when a filter module needs to be replaced. If the speed of the cleaned airflow is below a threshold value, for example, it can be assumed that the filter module is so contaminated that hardly any air can flow through it.

According to a further development, a chamber can be arranged on the outlet side in the receiving element, which serves to hold a filter material. In this way, a stage for ultra-fine filtration can be formed, which filters out the smallest particles from the airflow.

According to an advantageous embodiment, the receiving element can be reclosable or reopenable, with at least one closing element being formed on one side surface of the receiving element. Preferably, the closing element can be completely recessed within the side wall of the receiving element so that it does not hinder the arrangement of several filter modules on top of each other or next to each other to form a continuous surface.

According to an advantageous embodiment of the method of assembling a filter module, an essentially two-dimensional structure without cavities can be present before assembly by full-surface contact of the at least one longitudinal wall with the transverse walls, which is transformed into a three-dimensional structure with rectangular or square cavities by assembly without the transverse walls or the at least one longitudinal wall being bent.

Advantageously, the receiving element can also be available as a substantially two-dimensional structure and can be constructed in a similar way to a cardboard box. Both elements, i.e. the receiving element and the filter insert, can therefore be transported in a space-saving manner. Assembling the filter module also saves time and requires no prior knowledge.

The above embodiments and modifications may be combined with each other in any sensible way. Further possible embodiments, developments and implementations of the invention also comprise combinations not explicitly mentioned of features of the invention which are described above or below with respect to the exemplary embodiments. In particular, a skilled person will here also add individual aspects as improvements or supplements to the respective basic form of the present invention.

### SUMMARY OF THE DRAWING

The present invention will be explained in more detail below using the examples given in the schematic figures of the drawing, wherein: in which

FIG. 1 shows a schematic representation of the transverse walls of a filter insert arranged one behind the other;

FIG. 2 shows the transverse walls with openings from FIG. 1, arranged adjacent to each other;

FIG. 3 shows transverse walls arranged next to each other with openings in a further embodiment;

FIG. 4 shows a filter module with a receiving element and a filter insert with an open cover;

FIG. 5 shows another embodiment of a filter module;

FIG. 6 shows another embodiment of a filter module;

FIG. 7 shows a top view of the embodiment in FIG. 5;

FIG. 8 shows a top view of a further embodiment;

FIG. 9 shows transverse walls with differently arranged openings;

FIG. 10 shows an isometric representation of a filter insert;

FIG. 11 shows a side view of the filter attachment from FIG. 10 in a folded state;

FIG. 12 shows openings of the longitudinal wall compared to the openings of the transverse wall;

FIG. 13 shows an embodiment of a transverse wall with slots;

FIG. 14 shows an embodiment of a longitudinal wall with slots;

FIG. 15 shows another embodiment of a transverse wall;

FIG. 16 shows an embodiment of a filter module in an isometric view with a detailed view of a closing element.

The enclosed Figures are intended to provide a better understanding of the embodiments of the present invention. They illustrate embodiments and are used in conjunction with the description to explain principles and concepts of the invention. Other embodiments and many of the cited advantages emerge in light of the drawings. The elements of drawings the are not necessarily shown to scale in relation to one another.

In the figures of the drawing, elements, features and components that are the same, have the same function and have the same effect are each provided with the same reference signs-unless explained otherwise.

### DESCRIPTION OF EXEMPLARY EMBODIMENTS

FIG. 1 shows a schematic representation of transverse walls 7 of a filter insert 6 arranged one behind the other. The transverse walls 7 each have an opening 8, wherein adjacent openings 8 of adjacent transverse walls 7 are arranged vertically offset and/or vertically overlapping. As a result, an air flow 4, starting from the inlet side 3 in the direction of the outlet side 5, is deflected through the openings 4 at different vertical positions, while at the same time creating a wave-shaped, in particular laminar, airflow that does not exhibit any turbulence. The opening 8 of the transverse wall 7 on the left-hand side can also represent an opening 13 of the inlet side 3 of a receiving element 2, wherein the airflow to be cleaned 4a first flows through the opening 13. The cleaned airflow 4b exits on the right-hand side of the representation. A continuous airflow is generated in the all transverse walls 7, wherein a regions between deflection of the airflow 4′ parallel to the transverse walls 7 is prevented by the arrangement of the openings 8. Particles from the air to be cleaned can therefore adhere to all transverse walls 7 in a uniformly distributed manner. For this purpose, it is advantageous if the size of the openings 8 does not decrease continuously from the inlet side 3 in the direction of the outlet side 5, so as not to slow down the air flowing 4 inside the filter element too much.

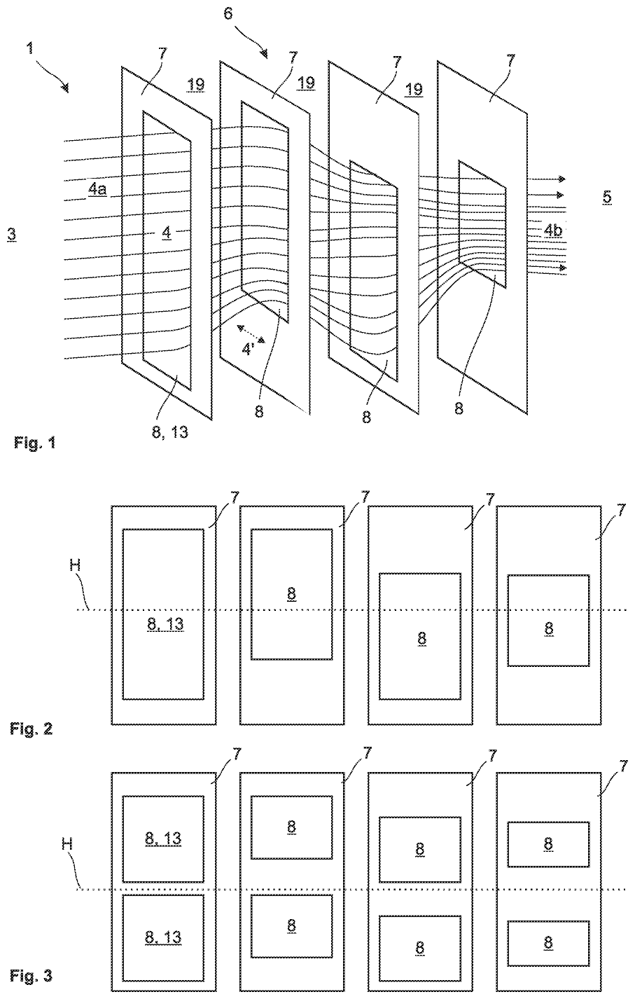

FIG. 2 shows the transverse walls 7 with openings 8 from FIG. 1. As a comparison, these are arranged next to each other. In this respect it is apparent that the openings 8 are arranged offset with respect to a horizontal axis H. The openings 8 of different transverse walls 7 can have openings 8 with identical dimensions, such as the two central transverse walls 7, although these are arranged offset to the horizontal axis H. This allows the air to be deflected at different vertical positions.

FIG. 3 shows transverse walls 7 arranged next to each other with openings 8 in a further embodiment. Contrary to the representation in FIG. 2, each transverse wall 7 has two openings 8. The air to be cleaned can thus flow in parallel through the two openings 8, whereby an airflow 4 comparable to FIG. 1 is generated with respect to the upper and lower opening 8.

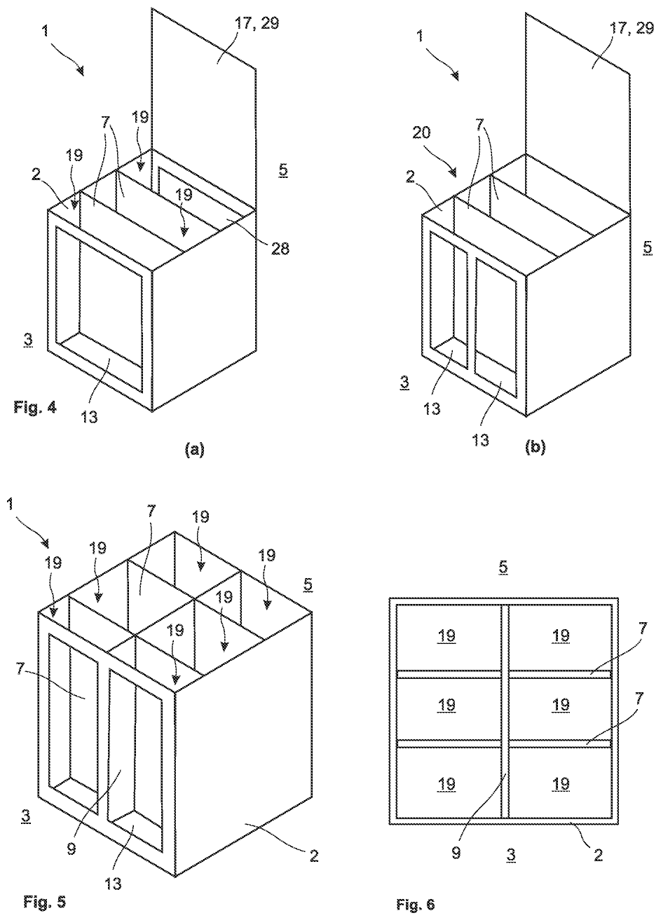

FIG. 4 (a) shows a filter module 1 with a receiving element 2 and a filter insert 6 with an open cover 29. The openings 8 in the transverse walls 7 are not shown for reasons of clarity. In this embodiment, the filter module 1 has two transverse walls 7, each of which runs across the entire width of the receiving element 2. An opening 13 is arranged on the inlet side 3, which can correspond, for example, to the opening 8 (not shown) of the transverse wall 7, which is arranged closest to the inlet side 3. Opposite the inlet side 3, an outlet side 5 is arranged on the receiving element 2, which has an opening 28. The opening 28 is preferably configured over almost the entire side surface of the receiving element 2 in order to ensure that the cleaned air 4b is discharged as quickly as possible. Two openings 13 are arranged on the inlet side 3 of the embodiment shown in FIG. 4 (b). The transverse wall arranged closest to the opening of the inlet side 3 can also have two openings 8 (not shown) arranged next to each other.

FIG. 5 shows another embodiment of a filter module 1 with a longitudinal wall 9. The transverse walls 7 are fixed at a distance by the longitudinal wall 9. Furthermore, an airflow 4′, shown in FIG. 1, can still be prevented. The transverse wall 9 is in contact with the receiving element 2 in a region in which the receiving element has no opening. This allows the airflow 4 to be optimally directed through a side surface 17 of the receiving element on the inlet side 3 to the filter insert 6. The opening of the outlet side 5 is not shown in this representation.

FIG. 6 shows a top view of the embodiment in FIG. 5. In this embodiment, a total of six cavities 19 are configured by the filter insert 6, with three cavities 19 arranged one behind the other. This allows two airflows 4 to be generated, which are separated from each other by a longitudinal wall 9 in the center of the receiving element 2. In this respect, each transverse wall 7 can have openings 8 in the region of each cavity 19, which are configured for example as shown in FIGS. 1 to 3.

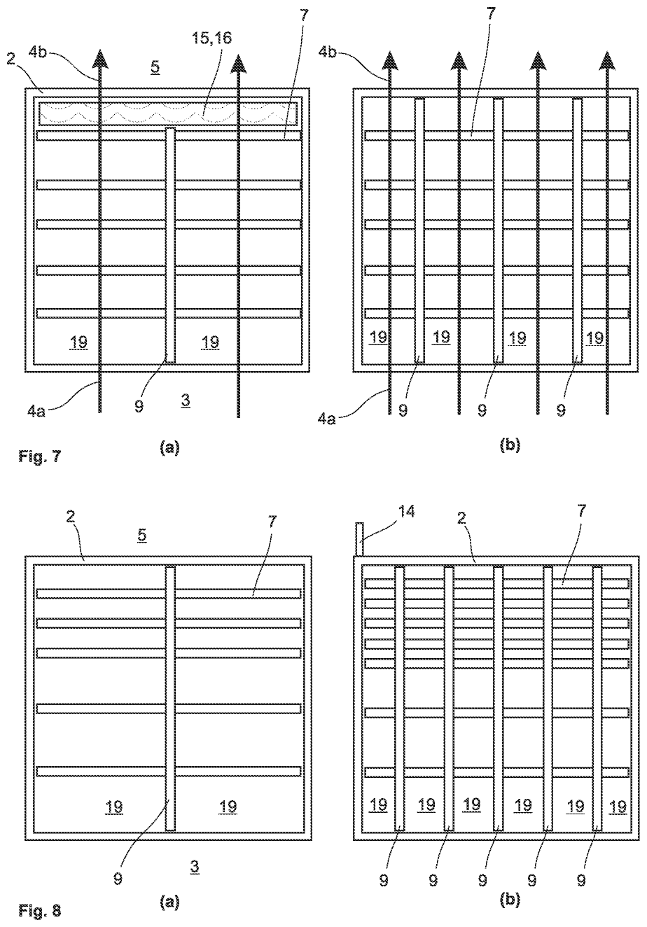

FIG. 7 shows two top views of two further embodiments. The direction of the airflow 4 is represented by the arrows. In FIG. 7 (a), the receiving element 2 has a chamber 15 on the outlet side 5, in which a filter material 16 is arranged. This means that the air to be cleaned 4a can be cleaned very finely in a final step. In FIG. 7 (b), the filter insert 6 has three longitudinal walls 9, so that a total of four air flows 4 are configured from the inlet side 3 in the direction of the outlet side 5, which run substantially parallel to each other. Each of the airflows 4 is a wave-shaped, in particular laminar, flow, with no meandering detour to adjacent airflows, i.e. parallel to the transverse walls 7, and therefore no deflection of the airflow to the left or to the right in the representation.

FIGS. 8 (a) and 8 (b) each show a top view of a further embodiment. In this embodiment, the transverse walls 7 are arranged at different distances from each other. Preferably, the transverse walls 7 are arranged at a greater distance from each other in the region of the inlet side 3, as most of the particles from the air to be cleaned adhere to the filter insert 6 in this region. In the region of the outlet side 5, the transverse walls 7 are arranged closer together. This allows fine cleaning of the airflow. With such an arrangement, it is particularly preferable to achieve an even distribution of the particles over the entire filter insert 6, so that the filter module 1 can be used effectively over a particularly long period of time.

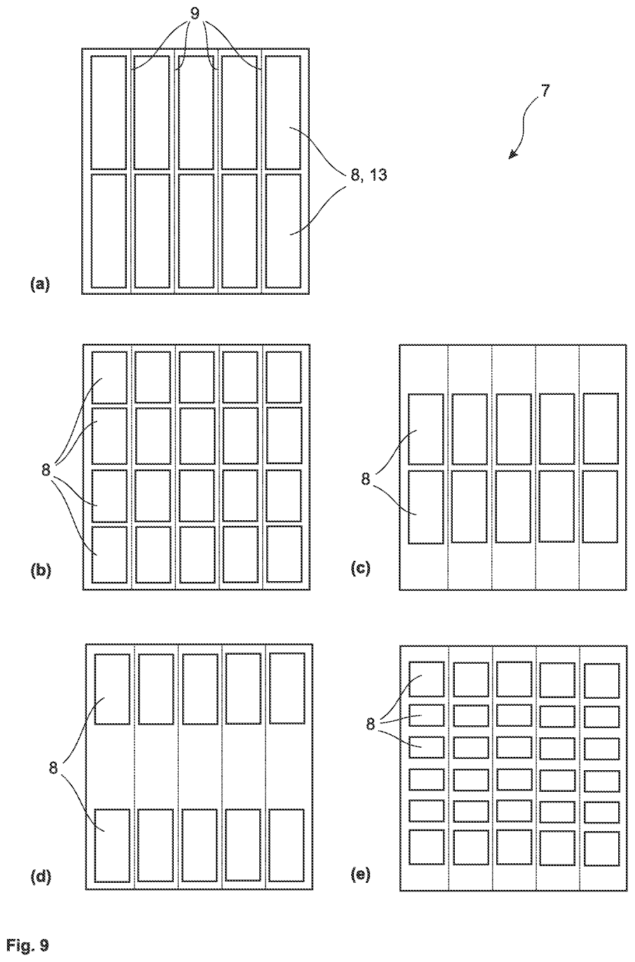

FIG. 9 shows transverse walls 7 with differently arranged openings 8. Within a receiving element 2, transverse walls 7 with such openings are preferably arranged one behind the other in the order starting with the design according to FIG. 9 (a) to FIG. 9 (e). The transverse wall 7 according to FIG. 9 (a) can form an inlet side 3 of the receiving element 2, whereby the openings 8 can also represent the openings 13 on the inlet side. Preferably, the transverse wall 7 as shown in FIG. 9 (a) is arranged closest to the inlet side 3. As a result, the transverse walls 7 as shown in FIG. 9 (e) are arranged closest to the outlet side 5. The transverse walls 7 according to FIGS. 9 (b) to 9 (d) are arranged one after the other between them and can, for example, be arranged at different distances from each other, as shown in FIG. 8. Preferably, the transverse walls 7 according to FIG. 7 also have such openings 8.

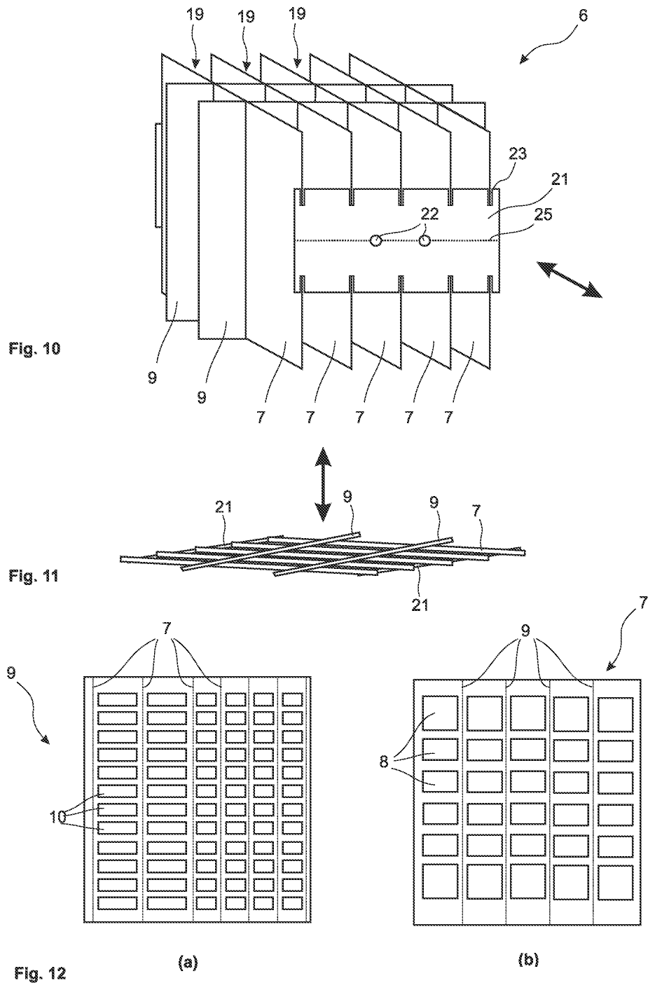

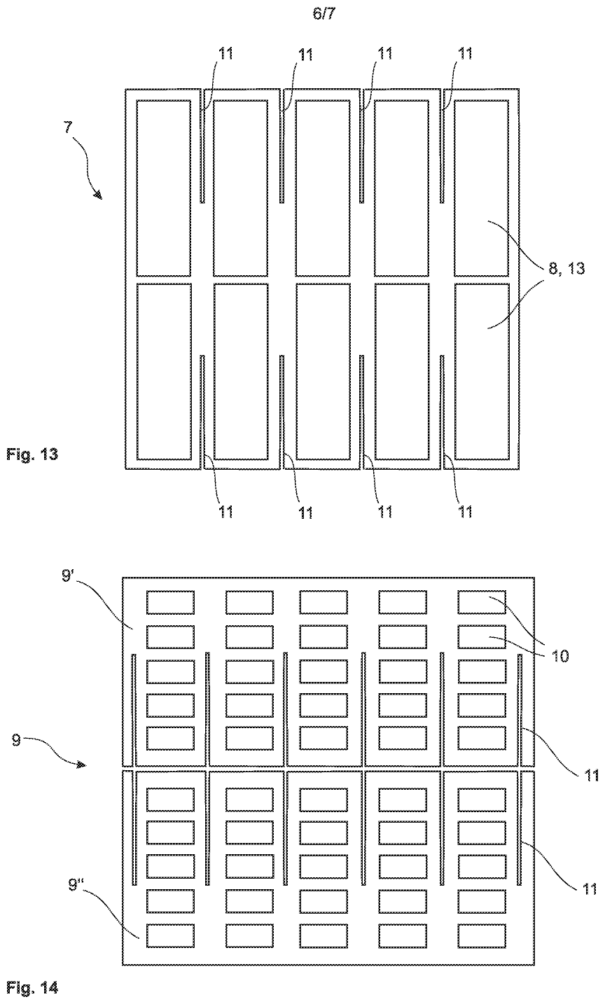

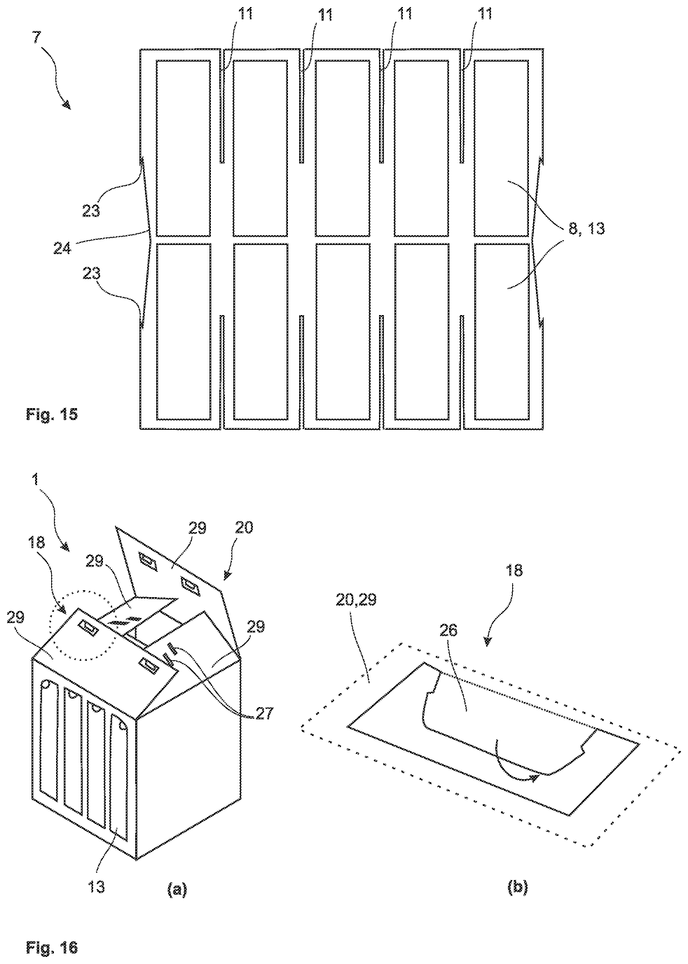

FIG. 10 shows an isometric representation of a filter insert 6. To form a three-dimensional structure, the transverse walls 7 and the longitudinal walls 9 are arranged substantially at right angles to each other. The transverse walls 7 can be inserted into the longitudinal walls 9, or vice versa, with both walls having slots 11. These are represented, for example, in FIG. 13 or FIG. 14. At one lateral end of the transverse walls 7, the transverse walls 7 can be connected to each other via a plate element 21. For this purpose, each transverse wall 7 can include receiving means 23 and recesses 24, shown in FIG. 15. The plate element 21 can be used to further reinforce the three-dimensional structure. The plate element 21 can, for example, have cutouts 22 into which an operator can reach with his fingers. This allows the plate element 21 to be easily removed. Advantageously, the plate element 21 also has a fold 25 that extends along the length of the plate element. If an operator now reaches into the cutouts 22 with their fingers, the plate element 21 folds along the fold 25 so that it can be removed more easily. Preferably, the plate element is configured slightly longer than the distance between the two receiving means 23, see FIG. 15, so that it can be securely clamped between them. The plate element can, for example, run along and rest against the recess 24, which also has a bend at the height of the fold 25.

FIG. 11 shows a side view of the filter attachment 6 from FIG. 10 in a folded state. It can be seen that the transverse walls 7 are tilted relative to the longitudinal walls 9 in order to obtain a three-dimensional structure as shown in FIG. 10 from a two-dimensional structure as shown in FIG. 11. When the filter insert 6 is set up to form a three-dimensional structure with rectangular or square cavities 19, the transverse walls 7 and the longitudinal walls 9 are therefore not bent. Overall, the filter insert 6 therefore has a high degree of stability. The folded filter insert can also be easily transported.

FIG. 12 (a) shows openings 10 of a longitudinal wall 9 compared with the openings 8 of a transverse wall 7. Each opening 10 of the longitudinal wall 9 is smaller than each opening 8 of the transverse wall 7, which is shown for comparison in FIG. 12 (b). The representation corresponds to that in FIG. 9 (e). As the openings 10 in the longitudinal walls 9 are comparatively small, an undulating, in particular laminar flow 4 from the inlet side in the direction of the outlet side can be ensured without resulting in a meandering course parallel to the transverse walls 7.

FIG. 13 shows an embodiment of a transverse wall 7 with slots 11. In this embodiment, a slot 11 is arranged between each of two adjacent openings 8, into which a longitudinal wall 9 can engage. In this embodiment, the transverse wall 7 therefore has slots 11 on an upper edge and on a lower edge, with two slots 11 lying in one plane or on one line in each case. The slots 11 are preferably each configured with an equal length. In particular, the slots 11 can each extend over 0.25 to 0.75 of the height of the transverse wall 7. Advantageously, the total length of both slots 11, which are in line, is half the height of the transverse wall 7. At high flow velocities in particular, the transverse walls 7 are configured to be particularly stable thanks to slots 11 that run over half the height of the transverse walls 7. The longitudinal walls 9 to be inserted into the slots 11 therefore preferably have slots 11 corresponding to the slots 11. These are represented for example in FIG. 14.

FIG. 14 shows an embodiment of a longitudinal wall 9 with slots 11. In this embodiment, the longitudinal wall 9 is configured in two parts, so that the upper part 9′ can be attached to the transverse wall as shown in FIG. 13 from above, and the lower part can be attached to the transverse wall as shown in FIG. 13 from below. The slots 11 are preferably configured to correspond to the slots 11 of the transverse walls 7, so that all slots 11 enable a plug-in connection between the transverse walls 7 and the longitudinal walls 9. In particular, the slots 11 of the longitudinal walls 9 each extend over 0.25 of the height of the longitudinal wall, in particular over a length of 0.2 to 0.3 of the height of the longitudinal wall 9.

In a further embodiment not shown, the two partial elements of the two-part longitudinal wall 9, shown in FIG. 14, can be connected to one another. In particular, this can be done using clamping strips, each of which connects a side edge of an upper sub-element to a side edge of a lower sub-element. In FIG. 14, a clamping strip could therefore be arranged on the left and right side edges. Advantageously, the airflow can be further influenced by the clamping guides.

FIG. 15 shows a further embodiment of a transverse wall 7. The transverse wall includes receiving means 23 and recesses 24 configured to receive the plate element 21 shown in FIG. 10. If, for example, transverse walls according to FIGS. 9 (a) to 9 (e) are used, each transverse wall can have such receiving means 23 and recesses 24.

FIG. 16 shows an embodiment of a filter module 6 in an isometric representation with a detailed view of a closing element 18. The closing elements 18 are arranged on the top side 20 of the receiving element 2. The top side 20 has four elements which together form a cover 29. There are two closing elements 18 arranged on each of two of the elements. Two further elements of the cover 29 each have two slots 27. The slots 27 are arranged offset to each other. Consequently, the closing elements 18 are also arranged offset to one another in the same way.

In the detailed view in FIG. 16 (b), it can be seen that the closing element 18 comprises a tab 26 which can engage in a slot 27 in a further element of the cover 29. The tab 26 is inserted into the slot 27 from above and bent in the direction of the arrow. As a result, the receiving element 2 has a flat top side 20. The top side 20 is configured similarly to a packaging carton, with two inner flaps and two outer flaps, which together form a cover 29.

In this embodiment, the receiving element 2 has four substantially rectangular openings 13 on the side surface that forms an opening of the inlet side 3. Before using the filter module 1, these can be closed by removable elements to prevent the filter insert 6 from becoming soiled. These removable elements can be easily removed by hand via access holes or cutouts. For this purpose, the shape of the openings 13 is preferably marked by a perforation. Similarly, the opening 28 on the outlet side 5 can initially be closed by a removable element.

Although the present invention has been fully described above using preferred examples, the present invention is not limited thereto, but may be modified in many ways.

For example, the openings 8, 10 and 13 can have different designs. In this respect, the shape may differ from the rectangular or square shape shown. Likewise, the arrangement of the openings can deviate from the way shown.

### LIST OF REFERENCE SIGNS

1 filter module
2 receiving element
3 inlet side
4 airflow
5 outlet side
6 filter insert
7 transverse wall
8 opening of the transverse wall
9 longitudinal wall
10 opening of the longitudinal wall
11 slot
12 interior space
13 opening of the inlet side
14 sensor
15 chamber
16 filter material
17 side surface
18 closing element
19 cavity
20 top side
21 plate element
22 cutout
23 Receiving means of the transverse wall
24 recess
25 fold
26 tab
27 slot
28 opening of the outlet side
29 cover
H horizontal axis

1.-18. (canceled)

19. A filter module for separating particles from contaminated air, the filter module comprising:
a receiving element which has an inlet side for admitting an airflow to be cleaned and an outlet side for discharging the cleaned airflow, the inlet side and the outlet side being arranged opposite to each other on the receiving element,
a three-dimensional filter insert, which is received in the receiving element,
wherein the filter insert has at least two transverse walls which are arranged approximately parallel to each other, and each transverse wall has at least one opening, and the openings of the transverse walls are vertically offset or overlap vertically such that the air flowing from the inlet side in the direction of the outlet side can be deflected onto different vertical levels through the openings such that the wave-shaped airflow can be formed from the inlet side in the direction of the outlet side such that particles from the airflow to be cleaned are adhered in the filter insert in a uniformly distributed manner.

20. The filter module of claim 19,
wherein the filter insert has at least three transverse walls, wherein the openings of adjacent transverse walls are vertically offset or overlap vertically.

21. The filter module of claim 19,
wherein each transverse wall has at least two openings and a longitudinal wall is arranged between two openings of a transverse wall, which fixes the transverse walls at a distance and prevents an air flowing parallel to the transverse walls.

22. The filter module of claim 21,
wherein the longitudinal wall has at least one opening which is smaller than the smallest opening of the transverse walls.

23. The filter module of claim 21,
wherein at least two longitudinal walls are comprised, said longitudinal walls being arranged approximately parallel to each other, each transverse wall having at least one opening in a region between the longitudinal walls.

24. The filter module of claim 23,
wherein the adjacent longitudinal walls each have at least one opening which is smaller than the smallest opening of the transverse walls and wherein the openings of the longitudinal walls having identical cross-sections or each being arranged at the same position with respect to adjacent longitudinal walls.

25. The filter module of claim 24,
wherein the transverse walls are not arranged in the region of the at least one opening of the longitudinal walls.

26. The filter module of claim 21,
wherein the transverse walls and the at least one longitudinal wall each have at least one slot, so that the transverse walls can be releasably fitted into the at least one longitudinal wall one inside the other.

27. The filter module of claim 1,
wherein the transverse walls extend over a complete length between the inlet side and the outlet side resulting in only one filter insert spanning an interior space of the receiving element.

28. The filter module of claim 1,
wherein the at least one longitudinal wall extends over a complete width of the receiving element, resulting in only one filter insert spanning an interior space of the receiving element.

29. The filter module of claim 1,
wherein the inlet side of the receiving element has at least one opening which corresponds to the at least one opening of the transverse wall located closest to the inlet side.

30. The filter module of claim 29,
wherein the at least one longitudinal wall does not intersect the at least one opening on the inlet side.

31. The filter module of claim 1,
wherein at least one of the receiving element or the filter insert contain a recyclable material.

32. The filter module of claim 1,
wherein the filter module is a paper filter module.

33. The filter module of claim 1,
wherein at least one sensor for measuring the velocity of the cleaned airflow or for measuring a resistance value is arranged on the outlet side.

34. The filter module of claim 1,
wherein a chamber is arranged on the outlet side inside the receiving element, said chamber serving to receive a filter material.

35. The filter module of claim 1,
wherein the receiving element is reclosable or reopenable, at least one closing element being formed on a side surface of the receiving element.

36. The filter module of claim 1,
wherein the filter module is configured for separating paint particles from an airflow within a paint mist extraction system.

37. A method of operating a filter module for separating particles from contaminated air, the filter module comprising: a receiving element which has an inlet side for admitting an airflow to be cleaned and an outlet side for discharging the cleaned airflow, the inlet side and the outlet side being arranged opposite to each other on the receiving element, a three-dimensional filter insert, which is received in the receiving element, wherein the filter insert has at least two transverse walls which are arranged approximately parallel to each other, and each transverse wall has at least one opening, and the openings of the transverse walls are vertically offset or overlap vertically such that the air flowing from the inlet side in the direction of the outlet side can be deflected onto different vertical levels through the openings such that the wave-shaped airflow can be formed from the inlet side in the direction of the outlet side such that particles from the airflow to be cleaned are adhered in the filter insert in a uniformly distributed manner,
wherein the air flowing from the inlet side in the direction of the outlet side is only deflected through the openings of the transverse walls onto different vertical positions within the filter insert, so that a wave-shaped airflow results and a deflection of the flow transverse to the different vertical positions is prevented.

38. A method of assembling a filter module for separating particles from contaminated air, the filter module comprising: a receiving element which has an inlet side for admitting an airflow to be cleaned and an outlet side for discharging the cleaned airflow, the inlet side and the outlet side being arranged opposite to each other on the receiving element, a three-dimensional filter insert, which is received in the receiving element, wherein the filter insert has at least two transverse walls which are arranged approximately parallel to each other, and each transverse wall has at least one opening, and the openings of the transverse walls are vertically offset or overlap vertically such that the air flowing from the inlet side in the direction of the outlet side can be deflected onto different vertical levels through the openings such that the wave-shaped airflow can be formed from the inlet side in the direction of the outlet side such that particles from the airflow to be cleaned are adhered in the filter insert in a uniformly distributed manner, wherein the method comprising:
erecting the transverse walls, which are fitted into the at least one longitudinal wall one inside the other and form the filter insert, so that an approximately two-dimensional structure is turned into a three-dimensional structure comprising cavities, said structure being stable in itself,
sliding the filter insert into the receiving element or into an open top side of the receiving element,
closing the receiving element by means of a cover, so that the filter insert can be fixed non-displaceably in the receiving element.

39. The method of claim 38,
wherein prior to erecting, by full-surface contact of the at least one longitudinal wall with the transverse walls, a substantially two-dimensional structure without cavities is obtained, which is transformed into a three-dimensional structure with rectangular or square cavities by erecting, without the transverse walls or the at least one longitudinal wall being bent.
